(19) United States
(12) Patent Application Publication
(10) Pub. No.: US 2026/0249309 A1
(43) Pub. Date: Aug. 27, 2026

(54) CENTRIFUGE AND METHOD FOR OPERATING THIS CENTRIFUGE

(71) Applicant: Andreas Hettich GmbH & Co. KG, Tuttlingen (DE)

(72) Inventors: Armin BRENDLE, Mühlhausen-Ehingen (DE); Florian BETZ, Rietheim-Weilheim (DE)

(21) Appl. No.: 19/106,626

(22) PCT Filed: Aug. 30, 2023
(86) PCT No.: PCT/EP2023/073792

§ 371 Date: Feb. 25, 2025

(30) Foreign Application Priority Data
Aug. 31, 2022 (DE) 10 2022 122 076.1

(51) Int. Cl. B04B 7/06; B04B 5/04; B04B 7/02; B04B 13/00

(52) U.S. Cl. CPC B04B 7/06; B04B 5/0414; B04B 13/00; B04B 2007/025

(57) ABSTRACT

A centrifuge comprises a housing, a rotor for receiving sample containers, a drive for driving the rotor, a rotor chamber within housing, with parts of rotor chamber delimited by a safety vessel and rotor mounted in rotor chamber, a control unit for controlling the drive for centrifuge samples in the sample containers, a lid for closing rotor chamber, operating unit with a display for displaying centrifuge parameters with at least one input means for inputting and/or selecting parameters and/or programs stored in operating unit. Selected parameters and/or programs are transferred from operating unit to control unit. Control unit is connected to at least one lid switch in terms of signaling. Upon closing lid, lid switch is activated when lid in closed position. Upon activating switch, control unit activates the drive according to parameters last input into operating unit and/or program last selected, if further basic parameters are met.

The invention relates to a centrifuge of the type specified in the preamble of claim 1, and to a method for operating this centrifuge according to claim 20.

This type of centrifuges, in particular laboratory centrifuges, for separating substances or mixtures of substances, preferably up to a speed of 17,000 rpm, in particular also samples up to 1,000 ml per rotor, have been known for some time now and are used, among other things, in the medical-pharmaceutical sector for treating mixtures of substances or for extracting blood plasma by centrifugation. Centrifugation can be carried out according to a specific process duration, a specific speed and a specific temperature profile. The prior art centrifuges essentially consist of a housing that can be closed by a lid, within which a replaceable rotor is arranged in a safety vessel. The safety vessel and the closed lid delimit a rotor chamber in which the rotor is arranged on a drive shaft. The drive shaft is coupled to an electric motor. Receptacles for inserting and removing sample containers are provided in the peripheral area of the rotor. The sample containers contain the mixtures of substances or blood samples to be treated, i.e. the samples in general. The rotor is connected to an electric motor. The rotor and the electric motor are arranged within the housing.

Depending on the rotor used and the sample containers inserted in it, there are different maximum speeds for safety reasons, but also for the desired process result, the observance of which must be monitored during operation of the centrifuge. Depending on the samples to be treated, there are further requirements, for example with regard to the process duration and the process temperature, which also require monitoring. The process duration, the process temperature and the process speed depend on the rotor used, the sample containers used and the samples to be centrifuged. Consequently, this data is entered and stored, for example via a control unit of the laboratory centrifuge, which, depending on the absolute scope of the data/parameters to be entered or of the programs to be activated or deactivated, results in complex setting procedures that require an appropriately configured operating unit of the control unit. The operating unit is therefore characterized by a large number of switch means. A display is provided to show various parameters for centrifuge operation. The operating unit has input means for entering the parameters for centrifuge operation and/or for selecting parameters for centrifuge operation stored in the control unit. For centrifugation, the data, parameters and programs are then transmitted to a centrifuge control unit which controls operation of the centrifuge.

Such a laboratory centrifuge is disclosed in EP 0 994 753B1 , in which a rotary push button is provided as an input means for entering the parameters for operating the centrifuge.

A generic centrifuge is disclosed in DE 10 2008 010 640 A1 .

DE 38 18 407 A1 likewise discloses a centrifuge with a lid that is monitored by sensors. However, this document does not go beyond of what is disclosed in DE 10 2008 010 640 A1 .

US 2021/0039114 A1 discloses a centrifuge that is started by entering a passcode. The lid is monitored by sensors so that the centrifuge can only be started when the lid is closed.

A disadvantage of these prior art centrifuges, however, is that the effort required to start operation of the centrifuge is very time-consuming.

It is the object of the invention, therefore, to improve on a centrifuge of the type specified in the preamble of claim 1 in order to simplify and, in particular, speed up the handling of the centrifuge.

This object is accomplished by the characterizing features of claim 1 in conjunction with the features of its preamble.

The invention is based on the realization that a lid-controlled switching operation can accelerate the start of centrifuge operation, even if no new parameters have been selected or newly entered. If no new parameters have been selected or entered, the centrifuge will always operate based on the parameters last entered or the program last selected if certain other conditions are met.

According to the invention, the control unit is therefore connected for signaling to at least one lid switch, in particular via signal lines. The lid switch can be activated when the lid is in its closed position. When the lid switch is activated, the control unit activates the drive of the rotor for centrifuge operation according to the parameters last entered into the control unit and/or a program last selected with the operating unit, if certain other conditions are met. This simplifies the handling of the centrifuge, in particular its start of operation. This is particularly effective for repetitive centrifugation operations with the same parameters and/or the same programs. At the same time, this ensures the operational safety of the centrifuge. For example, unintentional false starts can be avoided with critical rotor types or rotor sizes, i.e. rotors with high kinetic energy. This also applies to rotors with buckets, where individual buckets may be missing when the rotor starts up, which creates an enormous imbalance in the centrifuge. If the lid is closed and the basic parameters are met, the centrifuge starts automatically. No further measures are required. The basic parameters are simply queried by the control unit.

The basic parameters preferably relate to certain rotor types and/or certain rotor sizes that are installed in the centrifuges. As an alternative or in addition, the basic parameters can refer to certain speeds that were last entered and/or to certain programs that were last selected.

In one embodiment of the invention, at least one safety switch interacting with the control unit is provided. This safety switch can also be designed in the form of a programmed controller. The safety switch prevents the rotor drive from being activated if components of the centrifuge fail. This is a simple way of ensuring that the centrifuge cannot be started if there is a possible risk due to defective components as a result of its operation or if there are malfunctioning components.

The safety switch can be connected to sensors for detecting a failure of components of the centrifuge and to the control unit, which safety switch interacts with the control unit for activating and deactivating the drive. Interaction between the corresponding sensors and the control unit on the one hand allows component failure to be detected and on the hand prevents the drive from being activated if necessary.

In order to enable a compact design and simple manufacture, the operating unit, the display and the input devices are combined in one electronic assembly. The electronic assembly can be provided with at least one interface, namely a wired or wireless interface. This interface can then be used to easily output relevant operating data or to upload software updates.

Preferably, the control unit is connected for signaling to at least one imbalance sensor, a sensor for detecting the rotor speed, a temperature sensor, in particular temperature sensors arranged at different positions in the centrifuge, a rotor type identification sensor, and evaluates their signals accordingly for controlling the rotor. This also allows the centrifugation operation to be documented, which is necessary for certain samples and centrifugation operations.

In one embodiment of the invention, two lid switches are provided, which are connected to the control unit via signal lines. The control unit only activates the rotor drive when all lid switches are activated. This prevents a false start if the lid has not been closed properly.

The lid can be designed to be hinged about a pivot axis.

In order to enable the lid switch to be activated easily, the lid for activating the lid switch, or the lid switch itself has actuating means associated with the one or with each lid switch for activating the associated lid switch. In particular, the actuating means is arranged on the side remote from the pivot axis.

In a preferred embodiment of the invention, the lid has a blocking mechanism that blocks opening the lid after it has been closed. This prevents any unintentional opening of the lid and interruption of the centrifugation process in all cases.

Furthermore, it is advantageous for the blocking mechanism to comprise a locking element that can be moved between a blocking position and a release position thereof. The locking element blocks the lid during operation of the centrifuge. The locking element thus holds the lid in its closed position. It is then no longer possible to open the lid.

A servo motor can move the locking element between the blocking position and the release position. The blocking mechanism can thus be triggered and operated automatically.

In order to be able to detect the position of the locking element, a position sensor is provided which is connected to the control device. The drive of the rotor is only activated by the control device when the locking element is in its blocking position.

Preferably, the display is designed as an input device in the form of a touch display.

In order to set all parameters and programs for operating the centrifuge, the input means can be designed as part of the operating unit, which has at least one pulse generator with rotation direction detection and a switch independent of each other.

In particular, this may be involve at least one rotary push button used as an input means.

In addition or as an alternative, individual buttons can be provided as input means.

In particular, the control unit has a memory for various programs and/or parameters for transfer to the control unit for controlling and regulating operation of the centrifuge. This makes it easy to select parameters and programs from among those stored in the control unit without having to re-enter them every single time. Preferably via a data bus, the data in the form of parameters and/or programs is then transmitted to the control unit, which regulates or controls the centrifugation operation based on the data transmitted.

The parameters can be parameters from the following group:
Target speed of the rotor during centrifuge operation,
T-time for centrifuge operation at a target speed,
Target temperature in the rotor chamber of cooled centrifuges during centrifuge operation,
Time course of the start-up ramp at the start of centrifuge operation and of the braking ramp at the end of centrifuge operation,
Radius of the rotor inserted in the rotor chamber,
Start time, i.e., the point in time when the time for centrifuge operation begins, i.e. either when the rotor starts to rotate or when the target speed of the rotor is reached.

The rotary push button is designed to generate pulses by means of rotary movement with direction detection around its axis of rotation and as a switching movement for the vertical displacement movement in the direction of this axis, whereby the display shows the parameters and programs mentioned after control by the rotary push button.

In a further aspect of the invention, the object is accomplished by a method for operating a centrifuge of the type just described, in which operation of the centrifuge starts as soon as the lid is closed.

In particular, operation of the centrifuge only starts after the lid has been locked. Two conditions are therefore required in this case: the lid must be closed and the lid must be locked.

To increase safety of the centrifuge, centrifuge operation is prevented from starting as soon as one monitored component fails.

Preferably, centrifuge operation is always started either on the basis of the parameters last entered or of a program last selected.

In one embodiment of the invention, centrifuge operation can be activated by closing the lid only for certain basic parameters, for example for predetermined rotor types or rotor sizes, for predetermined speeds and/or predetermined programs.

This serves primarily to increase the operational safety of the centrifuge. For example, unintentional false starts can be avoided with critical rotor types or rotor sizes, i.e. rotors with high kinetic energy. This also applies to rotors with buckets, where individual buckets may be missing when the rotor starts up, which creates an enormous imbalance in the centrifuge.

Additional advantages, features and possible applications of the present invention will become apparent from the description which follows, in which reference is made to the embodiments illustrated in the drawings.

Throughout the description, the claims and the drawings, those terms and associated reference signs are used as are stated in the list of reference signs below. In the drawings,

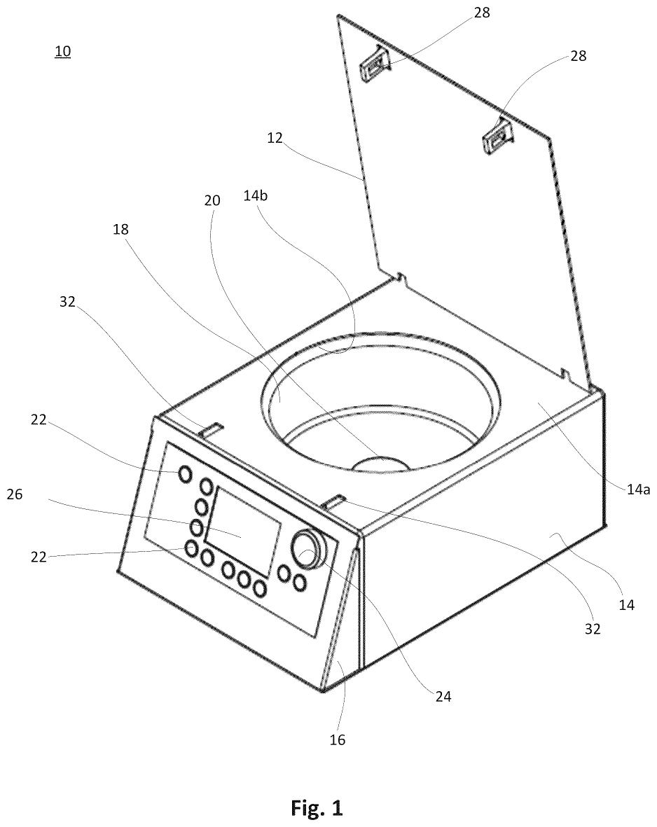

FIG. 1 is a perspective view, taken at an angle from above, of the centrifuge according to the invention with its lid open;

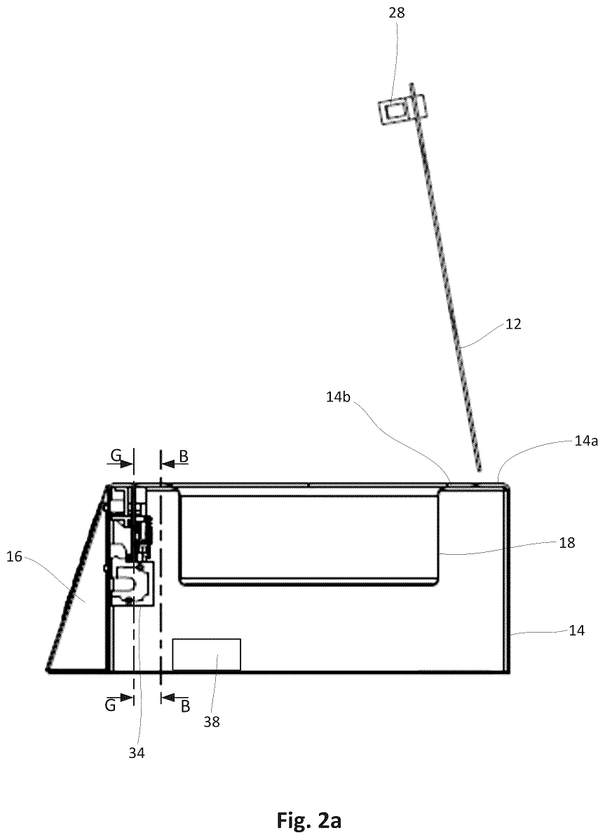

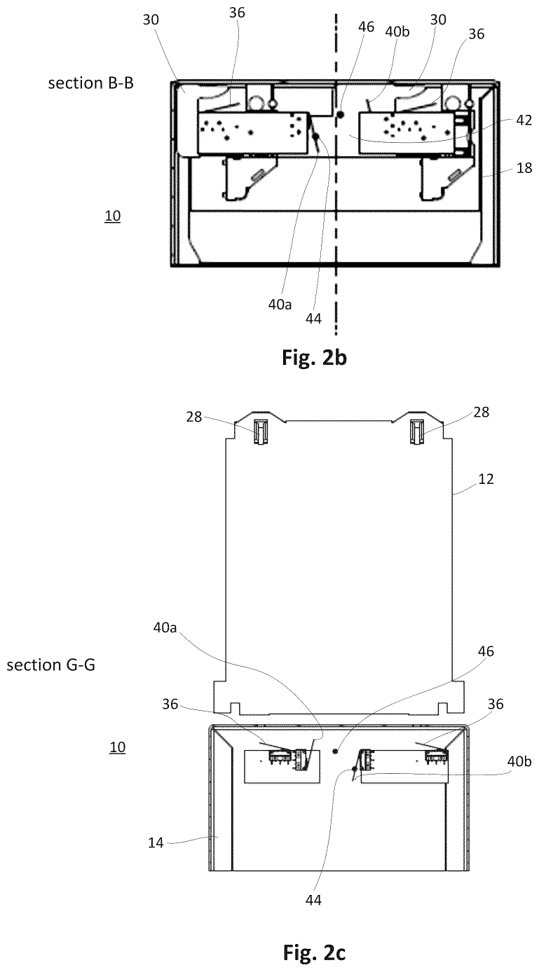

FIG. 2a is a sectional view along the center plane of FIG. 1;

FIG. 2b is a sectional view along line B-B of FIG. 2a;

FIG. 2c is a sectional view along line G-G of FIG. 2a;

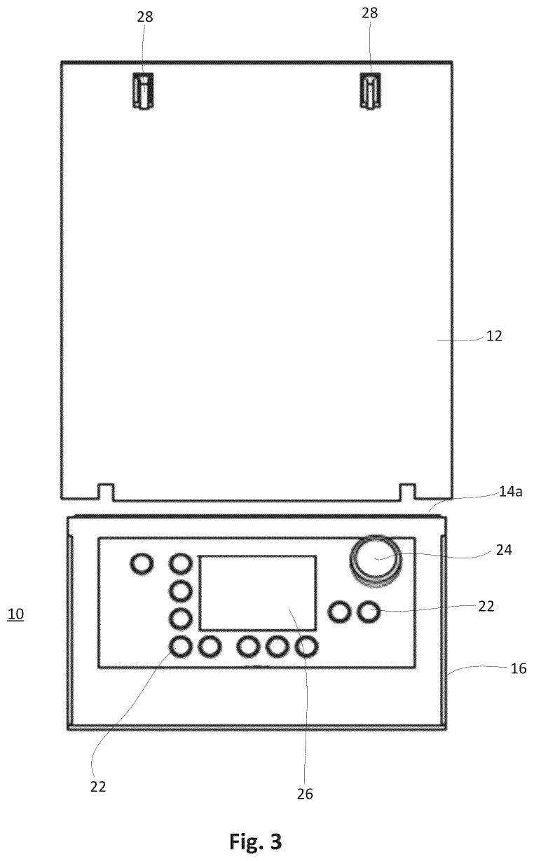

FIG. 3 is a front view of the centrifuge of FIG. 1;

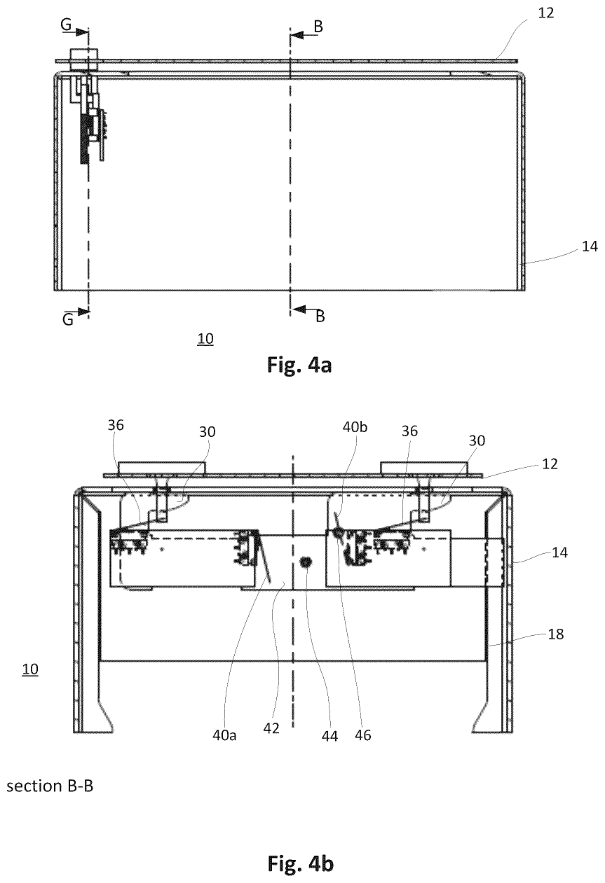

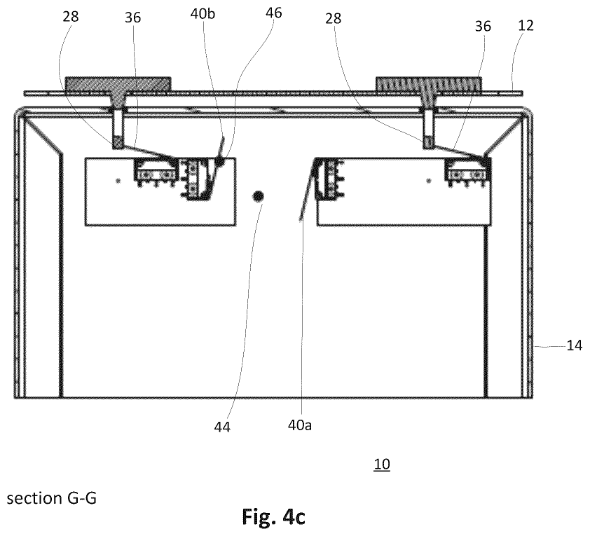

FIG. 4a is a sectional view along the center plane of FIG. 1, but with the lid closed;

FIG. 4b is a sectional view along line B-B of FIG. 4a, and

FIG. 4c is a sectional view along line G-G of FIG. 4a.

FIGS. 1 to 3 are different views each of a centrifuge 10 according to the invention with its lid 12 open, and FIGS. 4a to 4c are different views each of the centrifuge 10 with its lid 12 closed.

The centrifuge 10 has a housing 14 which is connected to an operating unit 16 on its front. A safety vessel 18 is arranged within the housing 14, which delimits a rotor chamber of the centrifuge 10. A rotor, not shown in detail here, is connected to a drive shaft 20 within the safety vessel 18. The drive shaft 20 drives the rotor, which is adapted for non-rotatable connection to the drive shaft. The lid 12 can be used to close the rotor chamber for operation of the centrifuge.

Via two hinge joints not shown in detail here, the lid 12 is pivotally connected and mounted to the housing 14 on the side of the housing 14 remote from the operating unit 16 in the upper region of the housing 12. For loading and unloading the rotor with sample containers, but also for replacing the rotor, for example with a different type of rotor for different applications, the lid 12 is opened and the user thus has free access to the rotor chamber, which is delimited in some areas by the safety vessel 18, with the rotor and the sample containers held in the rotor. The sample containers each contain the material to be centrifuged.

The front of the operating unit 16 is inclined and extends to an upper edge of the housing 14 at an angle of approximately 70° relative to a plane parallel to the base of the centrifuge 10.

Input means in the form of various buttons 22 and a rotary push button 24 are provided on the front of the operating unit 16. In addition, a touch display 26 is provided, which also serves as an input means. The input means are used to enter the parameters for operating the centrifuge and/or to select the parameters and operating programs stored in a memory for operating the centrifuge. The touch display 26 shows, among other things, the selected parameters/operating programs and/or the parameters/operating programs to be selected. The operating unit 16 is combined with the input means and the touch display 26 to form an electronic assembly. This electronic assembly is equipped with a wired or wireless interface use for entering data into, or reading data from, this electronic assembly.

On its side remote from the hinge joints on the inside of the lid 12, the lid 12 has two locking means 28, each in the form of an annular mount for a locking element 30. The locking means 28 are arranged at a distance from one another. A locking element 30 is assigned to each locking means 28 of the lid 12 in the housing 14. The locking elements 30 are coupled to one another and can be moved between an open position and a closed position thereof. In order to allow the locking means 28 to be pivoted together with the lid 12 to the locking elements 30 when moving from an open position to a closed position, a locking recess 32 associated with the locking means 28 is each provided in an upper wall 14a of the housing 14. The locking recess 32 is adapted to the outer contour of the associated locking means 28.

The upper wall 14a has a circular central recess 14b, which corresponds to the cross-sectional shape of the safety vessel 18.

The locking elements 30 can be moved between the open position and the closed position by means of a drive motor 34. In the closed position of the lid 12, the locking element 30 engages in the associated annular receptacle of the locking means 28. The lid 12 is pivoted downwards for this purpose. The lid 12 is in the closed position and is blocked by the locking elements 30 engaging in the locking means 28. The centrifuge 10 is thus closed.

Lid switches 36 are provided so that the locking element 30 is automatically moved from the open position to the closed position when the lid 12 is in its closed position. Via signal lines not shown in detail here, the lid switches 36 are connected to a control unit 38, see FIG. 2a. The lid switch 36 is operated by the associated locking means 28. If the lid 12 is closed, the locking means 28 have actuated the lid switches 36 and sent a corresponding signal to the control unit 38.

In addition, a first and second position switch 40a, 40b is provided for each locking element 30, which detects the position of the locking element 30. The locking elements 30 are coupled to one another via a connecting element 42, which is driven by the drive motor 34. A first trigger projection 44 is provided on the connecting element 42, which is assigned to the first position switch 40a. Furthermore, a second trigger projection 46 is provided on the connecting element 42 or on the locking element 30, which is assigned to the second position switch 40b. The trigger projections 44, 46 and the first and second position switches 40a, 40b can be seen in FIGS. 2b, 2c, 4b and 4c, respectively.

Each position switch 40a, 40b is connected to the control unit 38 via corresponding signal lines, which are not shown in detail here. If the locking elements 30 are in the closed position, the position switch 40b is actuated and a corresponding signal is sent to the control unit 38. If the locking elements 30 are in the open position, the position switch 40a was actuated and a corresponding signal was sent to the control unit 38.

If the locking elements 30 are moved into the closed position, the second trigger projection 46 on the connecting element 42 actuates the position switch 40b and sends a corresponding signal to the control unit 38, see FIG. 4b and FIG. 4c. If the locking elements 30 are moved into the open position, the first trigger projection 44 actuates the position switch 40a, see FIGS. 2b and 2a.

The control unit 38 automatically activates the operation of the centrifuge when
the lid 12 is closed and the lid switches 36 have thus been activated and have sent a corresponding signal to the control unit 38; and, at the same time,
the locking elements 30 are in their closed position, i.e. when they engage in the locking means 28 of the lid 12; and, at the same time,
the locking elements 30 are in their closed position, i.e. when they engage in the locking means 28 of the lid 12; and, at the same time,
the other basic parameters are met.

By closing the lid 12, the operation of the centrifuge 10 can thus be activated automatically, for example when the correct rotor for the previous program has been inserted. In this case, operation of the centrifuge 10 is activated according to the parameters/programs last entered or selected in the operating unit 16 and/or according to the program last entered/selected by closing the lid 12.

In this case, the basic parameters for automatically starting the centrifuge 10 upon closure of the lid 12 must be met. For example, the centrifuge 10 has sensors for detecting a failure of components of the centrifuge 10. These sensors are connected to the control unit 38. If such a sensor reports the failure of a component, this will prevent the centrifuge 10 from starting. Error or warning messages are then displayed to the user on the touch display 26.

Moreover, for safety reasons, the control unit 38 may also be connected for signaling to an imbalance sensor, a rotor speed detection sensor, a temperature sensor, in particular temperature sensors arranged at different positions in the centrifuge, a rotor type identification sensor, and the control unit 38 can evaluate the signals for controlling the rotor. The values of these sensors can be compared with the predefined basic parameters based on which the centrifuge 10 starts when the lid is closed. If these meet the basic parameters, the centrifuge 10 will start automatically upon closure of its lid 12.

The rotary push button 24 is designed for pulse generation by rotary movement with direction detection around its axis of rotation and as a switching movement for the vertical displacement in the direction of this axis. The touch display 26 shows the aforementioned parameters and programs. Furthermore, the rotary push button 24 designed in this way is allowed to change the values of parameters more quickly than the touch display 26 by means of software which enables a setting dynamic, in such a way that turning the rotary push button 24 faster results in larger steps in the parameter change, and turning it slower results in smaller steps in the parameter change. For example, the type of parameter can be changed by pressing the rotary push button 24.

Instead of a touch display 26, it is also possible to have only a display.

The parameters are then entered and selected using the setting buttons 22 and the rotary push button 24. The setting buttons 22 can be configured as favorite buttons which are used to access certain program modes. The setting buttons 22 can be assigned two functions. With four setting buttons 22, for example, the user then has 8 favorite options, each of which can be assigned a program for operating the centrifuge 10.

The operating unit 16 has a memory and a micro controller for storing various programs and/or parameters for controlling the operation of the centrifuge.

These parameters can be parameters from the following group:
Target speed of the rotor during centrifuge operation;
T-time for centrifuge operation at a target speed;
Target temperature in the rotor chamber of cooled centrifuges 10 during centrifuge operation;
Time course of an acceleration ramp at the start of centrifuge operation and of a deceleration ramp at the end of centrifuge operation;
Radius of the rotor installed in the rotor chamber;
Start time, i.e. the point in time when the time for centrifuge operation starts, i.e. either when the rotor starts to rotate or when the target speed of the rotor is reached.

In the centrifuge according to the invention, centrifuge operation starts as soon as the lid is closed and, in particular, the lid is locked. In addition, centrifuge operation is prevented from starting if the basic parameters are not met, for example if a monitored component fails or if the type or size of the rotor in the centrifuge does not match the parameters previously used.

Centrifuge operation is started either on the basis of the parameters last entered and/or a program last selected and the basic parameters for the respective operation of the rotor used. The basic parameters depend on the type and size of the rotor used. The speed and the assigned program are usually also related to this.

This enables the centrifuge to be handled more quickly in a simple way, which saves considerable time and therefore costs.

In addition, the operating unit 16 can be designed as a modular unit that can be detached from the housing 14 in order to easily provide various configuration options for the customer, such as a touch display or a normal display.

### LIST OF REFERENCE SIGNS

10 centrifuge
12 lid
14 housing
14a upper wall
14b circular recess in upper wall 14a
16 operating unit
18 safety vessel
20 drive shaft
22 button-input means
24 rotary push button-input means
26 touch display-input means
28 locking means
30 locking element
32 locking recess
34 drive motor for locking element 30
36 lid switch
38 control unit
40a position switch on the left
40b position switch on the right
42 connecting element
44 first trigger projection
46 second trigger projection

1-28. (canceled)

29. : A centrifuge (10), comprising
a housing (14),
a rotor for receiving sample containers,
a drive for driving the rotor,
a rotor chamber within the housing (14), wherein the rotor chamber is delimited in some areas by a safety vessel (18) and in which the rotor is mounted,
a control unit (38) for controlling the drive for carrying out a centrifuge operation for samples in a sample container of the rotor,
a lid (12) for closing the rotor chamber for centrifuge operation,
an operating unit (16) that is provided with a display (26) for displaying different parameters for centrifuge operation, and
at least one input means (22, 24, 26) for entering the parameters for centrifuge operation and/or for selecting parameters and/or programs for centrifuge operation stored in the operating unit (16),
wherein the selected parameters and/or programs are transmitted from the operating unit (16) to the control unit (38),
the control unit (38) is connected for signaling to at least one lid switch (36), the lid switch (36) can be activated, upon closure of the lid (12), when the lid (12) is in its closed state, and
wherein, when the lid switch (36) is activated, the control unit (38) activates the drive of the rotor for centrifuge operation in accordance with the parameters last entered into the operating unit (16) and/or in accordance with the program last selected, when certain further basic parameters are met.

30. The centrifuge according to claim 29, wherein the basic parameters relate to certain types and/or certain sizes of rotors that have been installed in the centrifuge.

31. The centrifuge according to claim 29, wherein the basic parameters refer to certain speeds that were last entered, and/or to certain programs that were last selected.

32. The centrifuge according to claim 29, wherein at least one safety switch interacting with the control unit (38) is provided, also in the form of a programmed controller, which prevents activation of the drive of the rotor in the event of failure of components of the centrifuge (10).

33. The centrifuge according to claim 32, wherein the safety switch is connected to sensors for detecting a failure of components of the centrifuge (10) and to the control unit (38), which safety switch cooperates with the control unit (38) for activating and deactivating the drive of the rotor.

34. The centrifuge according to claim 29, wherein the operating unit (16), the display (26) and the input means (22, 24, 26) are combined in an electronic assembly which is provided with an interface, and the interface is a wired or wireless interface.

35. The centrifuge according to claim 29, wherein the control unit (38) is connected for signaling to at least one imbalance sensor, a sensor for detecting the rotor speed, a temperature sensor, in particular temperature sensors arranged at different positions in the centrifuge, a rotor type identification sensor, and evaluates their signals for controlling the rotor.

36. The centrifuge according to claim 29, wherein two lid switches (36) are provided, which are connected to the control unit (38) via signal lines, with the control unit (38) activating the drive of the rotor only when all lid switches (36) are activated.

37. The centrifuge according to claim 29, wherein the lid (12) is designed to be foldable about a pivot axis.

38. The centrifuge according to claim 35, wherein, for activating the one or plural lid switch(es) (36), the lid (12) has an actuating means (28) assigned to the or each lid switch (36) for activating the associated lid switch (36), which actuating means (28) is arranged in particular on the side remote from the pivot axis.

39. The centrifuge according to claim 29, wherein the lid (12) has a blocking mechanism which blocks the lid (12) from being opened after it has been closed.

40. The centrifuge according to claim 39, wherein the blocking mechanism comprises a locking element (30) that can be moved between a blocking position and a release position thereof.

41. The centrifuge according to claim 40, wherein a servomotor (34) moves the locking element (30) between the blocking position and the release position thereof.

42. The centrifuge according to claim 40, wherein a position sensor (40a, 40b) is provided which detects the position of the locking element (30) and which is connected to the control device (38), with the control device (38) activating the rotor only when the locking element (30) is in the blocking position.

43. The centrifuge according to claim 29, wherein the display also forms an input means and is designed as a touch display (26) for this purpose.

44. The centrifuge according to claim 29, wherein, for setting all the parameters and programs for centrifuge operation, the input means (22, 24, 26) is provided as part of the operating unit (16) which is adapted for at least two independent movements.

45. The centrifuge according to claim 44, wherein at least one rotary push button is provided as an input means

46. The centrifuge according to claim 29, wherein individual keys (22) are provided as input means.

47. The centrifuge according to claim 29, wherein the operating unit (16) has a memory for various programs and/or parameters for controlling operation of the centrifuge as well as a micro controller.

48. The centrifuge according to claim 47, wherein these parameters are parameters from the following group:
Target speed of the rotor during centrifuge operation,
T-time for centrifuge operation at a target speed,
Target temperature in the rotor chamber of cooled centrifuges (10) during centrifuge operation,
Time course of an acceleration ramp at the start of centrifuge operation and a deceleration ramp at the end of centrifuge operation,
Radius of the rotor inserted in the rotor chamber, and
Start time, that is a point in time when time for centrifuge operation starts, that is either when the rotor starts to rotate or when the target speed of the rotor is reached.

49. The centrifuge according to claim 45, wherein the rotary push button (24) is adapted for switching movements as a rotary movement about its axis of rotation and as a vertical displacement movement in the direction of this axis, with the display (sixth 20) displaying the said parameters and programs.

50. A method for operating a centrifuge according to claim 29, wherein operation of the centrifuge starts as soon as the lid (12) is closed.

51. The method according to claim 50, wherein operation of the centrifuge starts as soon as the lid (12) is locked.

52. The method according to claim 50, wherein operation of the centrifuge is prevented from starting as soon as a monitored component fails.

53. The method according to claim 50, wherein operation of the centrifuge is started either on the basis of the parameters last entered and/or of a program last selected.

54. The method according to claim 50, wherein operation of the centrifuge is only activated for certain rotor types by closing the lid (12).

55. The method according to claim 50, wherein operation of the centrifuge is activated only for certain speeds by closing the lid (12).

56. The method according to claim 50, wherein operation of the centrifuge for predetermined programs is activated by closing the lid (12).
